(19) United States
(12) Patent Application Publication
(10) Pub. No.: US 2003/0174937 A1
(43) Pub. Date: Sep. 18, 2003

(54) Integrated WDM coupler for duplex communication

(76) Inventors: Yonglin Huang, Milpitas, CA (US); Shuqing Ma, San Jose, CA (US); Qi Deng, Cupertino, CA (US); Bing Zhang, San Jose, CA (US)

Correspondence Address: FISH & RICHARDSON P.C., 45 ROCKEFELLER PLAZA, SUITE 2800, NEW YORK, NY, 10111, US

(21) Appl. No.: 10/386,736

(22) Filed: Mar. 12, 2003

Related U.S. Application Data
(60) Provisional application No. 60/364,464, filed on Mar. 15, 2002.

(51) Int. Cl. G02B 6/28

(52) U.S. Cl. 385/24; 385/47

(57) ABSTRACT

An integrated wavelength division multiplexer (WDM) coupler is provided which performs multiple optical coupling functions; the WDM coupler includes a first multi-fiber end optical termination and a second multi-fiber end optical termination; a filter is provided between the optical terminations which reflects certain light and passes certain light; the first and second optical terminations and the filter are arranged in relation to one another so as to perform at least one coupling function upon each of at least two separate non-bi-directional optical signals.

### REFERENCE TO RELATED APPLICATION

This application claims priority from U.S. provisional patent application No. 60/364,464, filed on Mar. 15, 2002, entitled “Integrated WDM Coupler For Duplex Communication,” which is incorporated herein by reference in its entirety.

### BACKGROUND

The present disclosure relates in general to optical components, and more particularly, to optical couplers for wavelength division multiplexed networks.

In wavelength division multiplexed (WDM) fiber-optic networks, the wavelength of an optical (light) signal is used to direct the signal through the network to an intended destination. The optical signals of a particular wavelength constitute a corresponding communication channel over the network. In a single wavelength system, all information is carried in optical—signals of a single wavelength channel. In multiple wavelength systems, different wavelength channels can carry different information.

Some optical networks are duplex systems in which signals at a given node can be transmitted as well as received. One approach to implementing a duplex system is to use separate optical fibers to separately propagate optical signals in different directions. This type of system is sometimes referred to as a non-bi-directional system. There are several types of non-bi-directional systems including point-to-point, linear Add/Drop and ring-based. Optical signals propagated within a duplex non-bi-directional system may be processed separately. Processing may involve add/drops of optical signal wavelengths or may involve amplification of optical signal power, for example. Separate coupler modules have been used for substantially identical processing of optical signals propagated in different directions. For instance, two separate but identical coupler modules could be used to effect an optical Add/Drop multiplex (OADM) function on light propagated in opposite directions in separate non-bi-directional fibers. Similarly, for example, two separate but identical coupler modules may be used to effect a power amplification function on light propagated in opposite directions in different fibers.

Integrated WDM couplers have been produced for OADM functions and for optical amplifier functions. Couplers have been produced which include a WDM filter disposed between multiple first fiber ends and multiple second fiber ends. The WDM filter and the multiple first and second fiber ends may be arranged so that the coupler functions as an OADM. The OADM drops an optical signal at a given wavelength from the optical signal on one fiber end and adds an optical signal of the same given wavelength signal to an optical signal propagated by the filter to another fiber end. The WDM filter and the multiple first and second fiber ends may be arranged so that the coupler serves to combine a signal frequency, such as a 1550 nanometer (nm) wavelength signal, with a pump frequency, such as a 980 nm pump.

### SUMMARY OF THE DISCLOSURE

An integrated WDM coupler is provided which performs multiple optical coupling functions. The WDM coupler includes a first multi-fiber end optical termination and a second multi-fiber end optical termination. A filter and first and second collimating lenses are provided between the optical terminations, which reflect certain wavelengths of light and pass certain wavelengths of light. The first and second optical terminations, filter and lenses are arranged in relation to one another so as to perform at least one coupling function upon each of at least two separate non-bi-directional optical signals. In one aspect of the invention, the at least one optical coupling function performed on each of at least two separate non-bi-directional optical signals comprise optical add/drop multiplex functions. In another aspect of the invention, the optical coupling functions comprise pump combining functions.

Other features and advantages will be readily apparent from the detailed description, the accompanying drawings, and the claims.

### BRIEF DESCRIPTION OF THE DRAWINGS

FIG. 1 is an illustrative drawing of an integrated WDM coupler in accordance with the present disclosure.

FIG. 2 is a functional diagram illustrating optical add/drop multiplex (OADM) functions that may be performed by a coupler in accordance with one implementation.

FIGS. 3A-3B are illustrative partially exploded views that show internal components of an optical OADM array coupler in accordance with one implementation.

FIG. 4 is an illustrative drawing of a pass characteristic of a notch filter used in the implementation of FIGS. 3A-3B.

FIGS. 5A-5B are illustrative partially exploded views that show internal components of a second implementation of an OADM array coupler having multiple notch filters.

FIGS. 6A-6B are illustrative partially exploded views that show internal components of a third implementation of an OADM array coupler.

FIG. 7 is an illustrative drawing of a pass characteristic of a band-pass filter used in the implementation of FIGS. 6A-6B.

FIG. 8 is an illustrative drawing of a WDM coupler configured to perform a pump combining function.

FIG. 9 is an illustrative drawing of a partially reflective filter used in the coupler of FIG. 8.

FIG. 10 is an illustrative drawing of a pass characteristic of the partially reflective filter of FIG. 9.

FIGS. 11A-11B are illustrative partially exploded views that show internal components of the pump combining coupler of FIG. 8.

### DETAILED DESCRIPTION

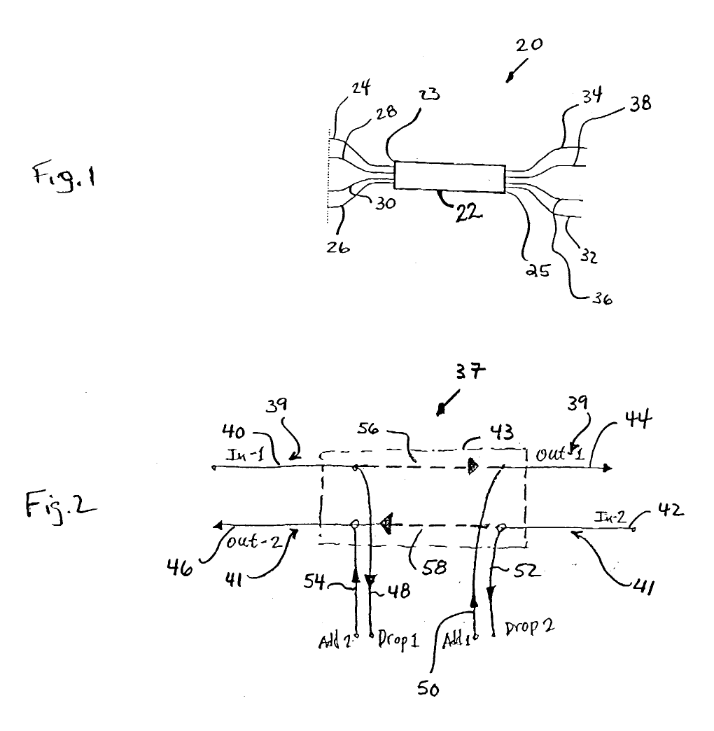

The present disclosure provides an integrated wavelength division multiplexed (WDM) coupler for duplex communication. In one embodiment a coupler is configured to perform an optical add/drop multiplexer function on optical signals on each of two different optical signal paths. In another embodiment a coupler is configured to combine at least two different wavelengths of light into each of two different optical fiber signal paths, for power amplification purposes, for example. FIG. 1 is an illustrative drawing of an integrated WDM coupler 20 in accordance with one implementation. The coupler 20 comprises an outer sleeve 22. The ends of a first set of multiple optical fibers 24-30 are unjacketed so that only the core and cladding of the fiber ends are inserted into an aperture (not shown) which runs longitudinally through at least a portion of a first end segment 23 of the sleeve 22. Ends of a second set of multiple fibers 32-38 are similarly unjacketed and are inserted into an aperture which runs longitudinally through at least a portion of a second end segment 25 of the sleeve 22. The sleeve 22 is elongated and may be substantially cylindrical in shape, and the first and second sleeve end segments 23, 25 can be at opposite ends of the sleeve 22.

FIG. 2 is a functional diagram 37 illustrating optical add/drop multiplex (OADM) functions that may be performed on optical signals on separate optical paths by a coupler in accordance the implementation of FIG. 1. A first optical signal path 39 proceeds from a first input optical fiber 40 to a first output optical fiber 44. A second optical signal path 41 proceeds from a second input optical fiber 42 to a second output optical fiber 46. A first drop signal having a prescribed wavelength is dropped from the first input optical signal on fiber 40 and is propagated onto fiber 48. A first add signal provided on fiber 50, and having substantially the same prescribed wavelength as the first dropped signal, is added to the first output signal propagated on fiber 44. A second drop signal having substantially the same prescribed wavelength as the first drop signal is dropped from the second input optical signal 42 and is propagated onto fiber 52. A second add signal provided on fiber 54, having substantially the same prescribed wavelength as the first and second dropped signals, is added to the second output signal propagated on fiber 46. The ray 56 indicated by dashed lines, represents the propagation of the first optical signal, without the first dropped signal, on the first optical path indicated by dashed lines, 39 from the first input fiber 40 to the first output fiber 44. The ray 58 represents the propagation of the second optical signal, without the second dropped signal, on the second optical path 41 from the second input fiber 42 to the second output fiber 46.

Thus, the OADM coupler function illustrated in FIG. 2 involves two OADM functions. First, optical signal light of the prescribed wavelength is dropped from the first optical signal path 39, and optical signal light of the same prescribed wavelength is added to the first optical signal path 39. Second, optical signal light of the same prescribed wavelength is dropped from the second optical signal path 41, and optical signal light of the same prescribed wavelength is added to the second optical signal path 41. Since the first and second input optical signals may propagate in opposite directions, the OADM coupler function may be used to perform an OADM function on light in both directions in a non-bi-directional optical communication system. The opposite directions may include one direction which is from the equipment side and toward the network side and an opposite direction which is from the network side and toward the equipment side. Moreover, opposite directions may include the East and West directions on a ring-based system.

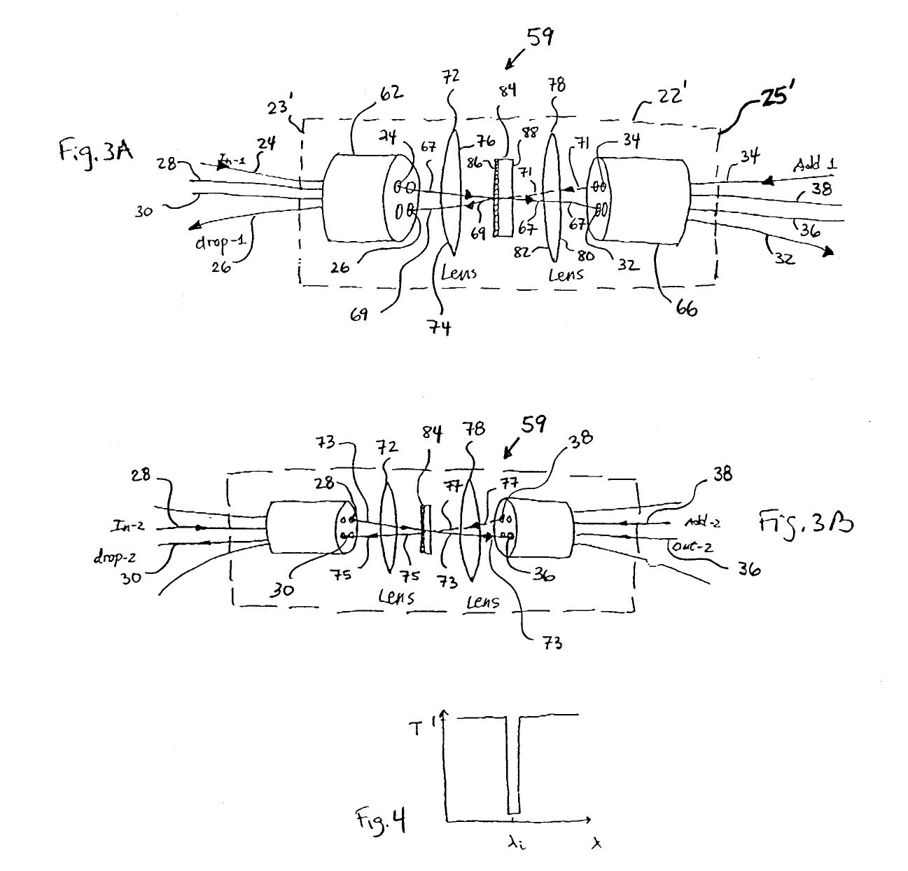

FIGS. 3A-3B show diagrams of an optical OADM array coupler 59 in accordance with an implementation. The drawings of FIGS. 3A-3B are identical except that FIG. 3A shows first internal light paths followed corresponding to a first add/drop multiplex function, and FIG. 3B shows second internal light paths corresponding to a second add/drop multiplex function. Identical reference numerals are used in FIGS. 3A-3B to represent identical components. Components identical to corresponding components in FIG. 1 are labeled with identical primed reference numerals.

An outer sleeve is represented by dashed lines labeled 22′. Ends of first, second, third and fourth fibers 24-30 extend through a first sleeve end segment 23′ of the outer sleeve 22′. The first through fourth fiber ends are enclosed within a first inner sleeve segment 62 inside the outer sleeve 22′. These first to fourth fiber ends together comprise a first optical termination. Similarly, ends of fifth, sixth, seventh and eighth optical fibers 32-38 extend into a second end segment 25′ of the outer sleeve 22′. These fifth to eighth fiber ends together comprise a second optical termination. The fibers 32-38 are enclosed within a second inner sleeve segment 66 within the outer sleeve 22′. Inner sleeve segment 62 and inner sleeve segment 66 include respective apertures through which the first set of fiber ends (first to fourth) and the second set of fiber ends (fifth to eighth) extend. The first and second inner sleeve segments 62, 66 hold the two sets of fiber so that they face each other within the outer sleeve 22′.

In an implementation, there are the same number of fiber ends in each of the first and second sets of fiber ends. The two lenses are in a confocal position with respect to each other. The filter is disposed near the focal point between the lenses. There is a one-to-one correspondence between the fibers in each set. Corresponding fiber ends are aligned so as to be in a mirror image relation with respect to each other. This alignment permits light from one fiber in one set to be passed to another fiber in a prescribed relative position in the other set. This alignment can be achieved, for example, by passing all of the fibers through a ferrule and cleaving it so that corresponding fiber ends are in alignment. In another embodiment, the fiber ends in the first and second sets may be beveled or angle polished to suppress reflections.

A first collimating lens 72 including a first face 74 and a second face 76 may be positioned within the outer sleeve 22′ between the first and second sets of optical fiber ends such that first face 74 is disposed proximate to the first through fourth fiber ends 24-30. A second collimating lens 78 including a first face 80 and a second face 82 may be positioned within the outer sleeve 22′ between the first and second sets of optical fiber ends such that first face 80 is disposed proximate the fifth through eighth fiber ends 32-38. A wavelength dependent filter 84 may be positioned within the outer sleeve 22′ between the first and second collimating lenses 72, 78. The filter 84 includes a first side 86 disposed proximate the second face 76 of the first collimating lens 72. In some implementations, only one side of the filter is functional, so the second side 88 may have no significant relationship with collimating lens 78.

The first and second collimating lenses 72, 78 may be implemented as GRIN lenses, simple convex lenses, aspherical lenses or ball lenses. The filter 84,may be implemented as a wavelength selective filter such as a thin film filter.

FIG. 4 is an illustrative drawing of a pass characteristic of filter 84. In the implementation of FIGS. 3A-3B, the wavelength dependent filter 84 includes a notch filter that passes all wavelengths within a prescribed wavelength band except wavelength λᵢ. Light at a wavelength λᵢ is reflected by filter 84.

The dashed line rays between the first and second sets of fiber ends shown in FIG. 3A represent first internal light paths corresponding to a first OADM function. A first input optical signal is provided on the first fiber 24. A portion of the first input signal is propagated to the fifth fiber 32. Another portion of the first input signal, having a wavelength λᵢ, is dropped from the first input optical signal and is reflected onto the second fiber 26. A first added signal at wavelength λᵢ is provided on the sixth fiber 34 and is passed to the fifth fiber 32. The dashed-line rays 67, 69, 71 incident upon the first, second, fifth and sixth fiber ends and intervening components between those ends represent first internal light paths within the coupler 59 which are discussed in the following paragraph.

The first optical termination including the first to fourth fiber ends 24-30 may provide a first array of fiber ends. The second optical termination comprising the fifth to eighth fiber ends 32-38 may provide a second array of fiber ends. Filter 84 and lenses 72, 78 direct light along light paths between the two arrays so as to perform two OADM functions involving two sets of input signals, output signals, add signals and drop signals.

Referring to FIG. 3A, the first and second sets of fiber ends, the lenses 72, 78 and the filter 84 may be arranged to effect the first internal light paths described with reference to FIG. 3A. A first input optical signal is propagated on the first fiber 24. The first input optical signal passes from fiber end 24 along a light path indicated by ray 67 through the first collimating lens 72 which collimates first input light from fiber 24. A portion of the first input optical signal light that has wavelength λᵢ is reflected by the filter 84 so as to proceed along a light path indicated by ray 69. The light reflected along ray 69 constitutes the first dropped signal light. The reflected/dropped portion of the first input optical signal, following light path 69, passes back through lens 72 which focuses the reflected portion onto the second fiber end 26, which propagates the first reflected/dropped signal light. Light of the first input signal on the first fiber 24 that is not at wavelength λᵢ continues along the light path indicated by ray 67 and passes through the filter 84 and passes through the second collimating lens 78 which focuses the first input optical signal, without the reflected/dropped portion having wavelength λᵢ, along light path 67 onto the fifth fiber end 32. The light that continues through the filter 84 along ray 67 constitutes the passed portion of the first input signal light. A first add signal including light having a wavelength of λᵢ passes from the sixth optical fiber end 34, along the light path indicated by ray 71, through the second collimating lens 78 which collimates the first add signal. The filter 84 reflects the first add signal back through the second collimating lens 78, along the light path 67. The second collimating lens 78 focuses the reflected first add signal onto the end of the fifth optical fiber 32. Thus, in the fifth fiber 32, the first add signal combines with the passed portion of the first input light signal to form the first output signal light.

Referring to FIG. 3B, the dashed line rays between the first and second sets of fiber ends second internal light paths correspond to a second OADM function. A second input optical signal is provided on the third fiber. A portion of the second input signal is propagated to the seventh fiber. Another portion of the second input signal, having a wavelength λᵢ, is dropped from the second input optical signal and is passed onto the fourth fiber 30. A first added signal at wavelength λᵢ is provided on the eighth fiber 38 and is passed to the seventh fiber 36. The dashed-line rays 73, 75, 77 incident upon the third, fourth, seventh and eighth fiber ends and intervening components between those ends represent second internal light paths within the coupler 59 which are discussed below.

The first and second sets of fiber ends, the lenses 72, 78 and the filter 84 are arranged to effect the second internal light paths. A second input optical signal is propagated on the third fiber 28. The second input optical signal passes from fiber end 28 along a light path indicated by ray 73 through the first collimating lens 72 which collimates first input light from fiber 28. A portion of the second input optical signal light that has wavelength λᵢ is reflected by the filter 84 so as to proceed along a light path indicated by ray 75. The light reflected along ray 75 constitutes the second dropped signal light. The reflected/dropped portion of the second input optical signal, following light path 75, passes back through lens 72 which focuses the reflected portion onto the fourth fiber end 30, which propagates the second reflected/dropped signal light. Light of the second input signal on the third fiber 28 that is not at wavelength λᵢ continues along the light path indicated by ray 73 and passes through the filter 84 and passes through the second collimating lens 78 which focuses the second input optical signal, without the reflected/dropped portion having wavelength λᵢ onto the seventh fiber end 36. The light that continues through the filter 84 along light path 73 constitutes the passed portion of the second input signal light. A second add signal including light having a wavelength of λᵢ passes from the eighth optical fiber end 38, along the light path indicated by ray 77, through the second collimating lens 78 which collimates the second add signal. The filter 84 reflects the second add signal back through the second collimating lens 78, along the light path 73. The second collimating lens 78 focuses the reflected first add signal along light path 73 onto the end of the seventh optical fiber 36. Thus, in the seventh fiber 36, the second add signal combines with the passed portion of the second input light signal to form the second output signal light.

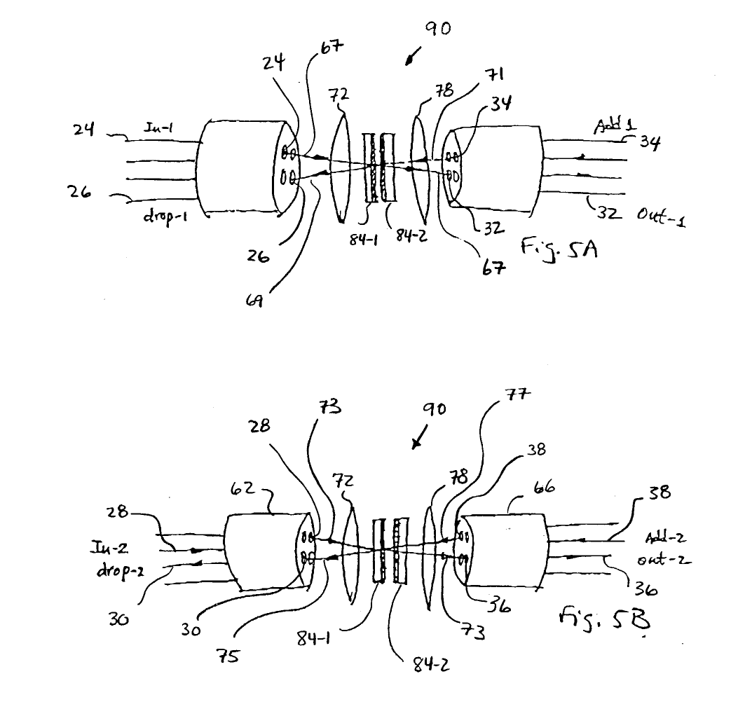

FIGS. 5A-5B illustrate an OADM array coupler 90 having two notch filters 84-1, 84-2. The overall operation of the coupler 90 of FIGS. 5A-5B is similar to the operation of the coupler 59 of FIGS. 3A-3B. The use of multiple cascaded filters may improve isolation between the add and or drop wavelengths. However, the use of multiple cascaded filters may increase the insertion loss. Thus, generally, there is a tradeoff to be considered between isolation and insertion loss when deciding whether to use one filter or multiple cascaded filters. The cascaded filter may be double side thin film coated on two sides of one substrate.

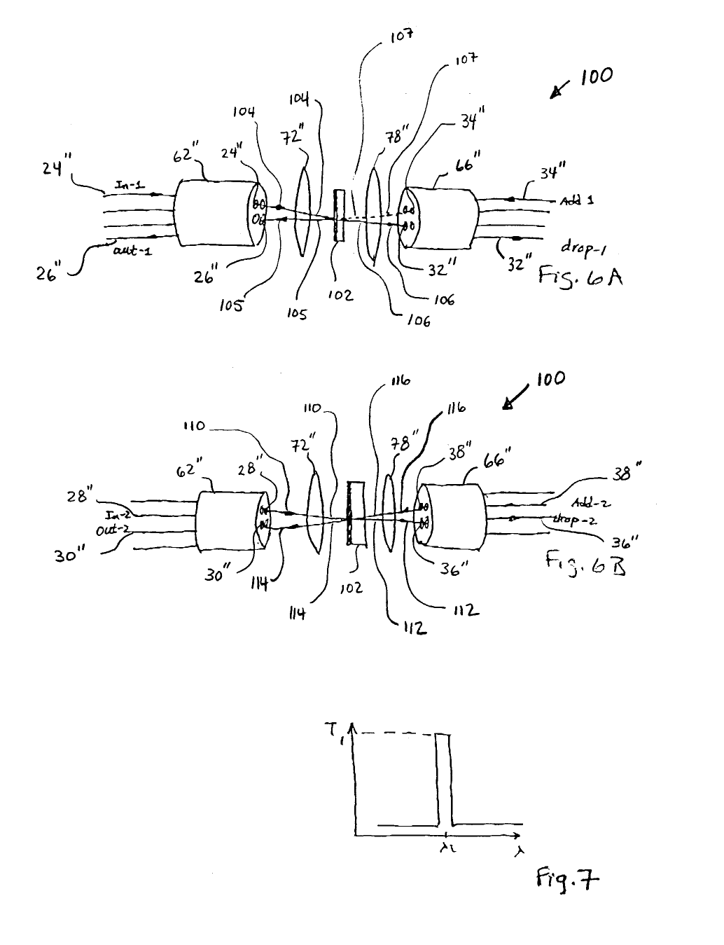

FIGS. 6A-6B illustrate another embodiment of an OADM array coupler 100. OADM array coupler 100 can be configured with components that are essentially the same as those of the previously described OADM array couplers 59, 90 of FIGS. 3A-3B and 5A-5B, respectively, except that the wavelength selective filter 102 of coupler 100 is a band pass filter instead of a notch (or band stop) filter. Consequently, the fibers on which the drop signals and the output signals are provided in the coupler 100 are reversed relative to the fibers on which those signals are provided in the couplers 59, 90. Accordingly, components of the third OADM array coupler 100 that are essentially the same as corresponding components of the couplers 59, 90 of FIGS. 3A-3B and 5A-5B are labeled with double primed reference numerals identical to those used for the corresponding components in FIGS. 3A-3B and 5A-5B.

FIG. 7 is an illustrative drawing of a pass characteristic of filter 102. In the implementation of FIGS. 6A-6B, the wavelength dependent filter 102 includes a band pass filter that reflects all wavelengths within a prescribed wavelength band except wavelength λᵢ. Light at a wavelength λᵢ is passed by filter 102.

The first and second sets of fiber ends, 24″-30″ and 32″-38″, respectively, the lenses 72″, 78″ and the filter 102 are arranged to effect the first internal light paths described with reference to FIG. 6A. A first input optical signal is propagated on the first fiber 24″. The first input optical signal passes from fiber end 24″ along a light path indicated by ray 104 through the first collimating lens 72″ which collimates first input light from fiber 24″. A portion of the first input signal light that has wavelength λᵢ is passed by the filter 102 so as to proceed along a light path indicated by ray 106. The light passed along ray 106 constitutes the first dropped signal light. The passed/dropped portion of the first input optical signal, following light path 106, passes through the second lens 78″ which focuses the passed portion onto the fifth fiber end 32″, which propagates the first passed/dropped signal light. Light of the first input signal on the first fiber 24″ that is not at wavelength λᵢ is reflected by filter 102 along the light path indicated by ray 105 and is passed back through the first lens 72″ which focuses the first input optical signal, without the passed/dropped portion having wavelength λᵢ, onto the second fiber end 26″. A first add signal including light having a wavelength of λᵢ passes from the sixth optical fiber end 34″, along the light path indicated by ray 107, through the second collimating lens 78″ which collimates the first add signal. The filter 102 passes the first add signal light through to the second collimating lens 78″. The second collimating lens 78″ focuses the passed first add signal onto the end of the second optical fiber end 26″. Thus, in the second fiber 32″, the first add optical signal combines with the reflected portion of the first input optical signal to form the first output optical signal.

Similarly, the first and second sets of fiber ends, 24″-30″ and 32″-38″, the lenses 72″, 78″ and the filter 102 are arranged to effect the second internal light paths described with reference to FIG. 6B. A second input optical signal is propagated on the third fiber 28″. The second input optical signal passes from fiber end 28″ along a light path indicated by ray 110 through the first collimating lens 72″ which collimates first input light from the third fiber 28″. A portion of the second input signal light that has wavelength λᵢ is passed by the filter 102 so as to proceed along a light path indicated by ray 112. The light passed along ray 112 constitutes the second dropped signal light. The passed/dropped portion of the second input optical signal, following light path 112, passes through the second lens 78″ which focuses the passed portion onto the seventh fiber end 36″, which propagates the second passed/dropped signal light. Light of the second input signal on the third fiber 28″ that is not at wavelength λᵢ is reflected by filter 102 along the light path indicated by ray 114 and is passed back through the first lens 72′ which focuses the first input optical signal, without the passed/dropped portion having wavelength λᵢ, onto the fourth fiber end 30″. A second add signal including light having a wavelength of λᵢ passes from the eighth optical fiber end 38″, along the light path indicated by ray 116, through the second collimating lens 78″ which collimates the first add signal. The filter 102 passes the second add signal light through to the second collimating lens 78″. The second collimating lens 78′ focuses the passed second add signal onto the fourth optical fiber end 30″. Thus, in the fourth fiber 30″, the second add optical signal combines with the reflected portion of the second input optical signal to form the second output optical signal.

FIG. 8 illustrates a WDM coupler 120 configured to perform a pump combining function. The coupler includes an outer sleeve 121 and first and second sets of fibers 122-128 and 130-136. The coupler 120 is configured to combine pump light from two pump light sources with communication signal light from two communications signal sources and also to provide two tap signals for monitoring purposes, for example. The fibers of the first set of fibers 122-128 and the fibers of the second set of fibers 130-136 are labeled with the types of signals thereon during operation. The insertion of the fibers in the coupler 120 of FIG. 8 is the same as that described above for coupler 20 of FIG. 2.

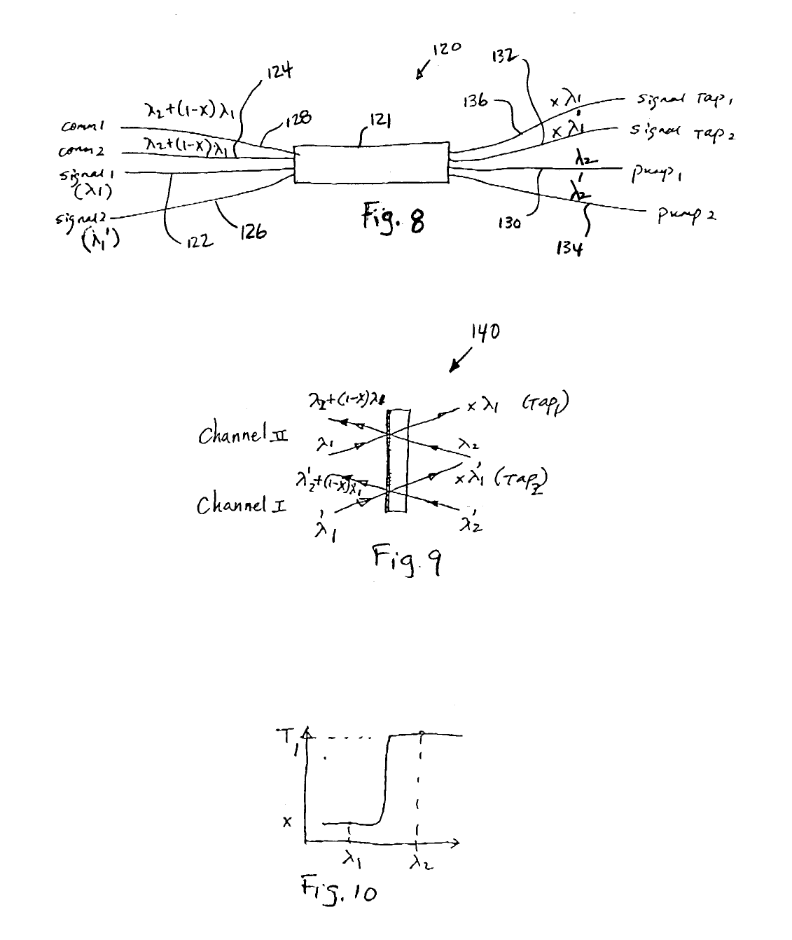

FIG. 9 is an illustrative drawing of a partially reflective filter 140 that may be used in the coupler 120 of FIG. 8. The coupler 120 may be used to combine multiple communications signals with multiple pumps and to provide multiple tap signals. The drawings of FIG. 9 illustrate the passage and reflection by filter 140 of two communications signals, two pump light and two tap signals.

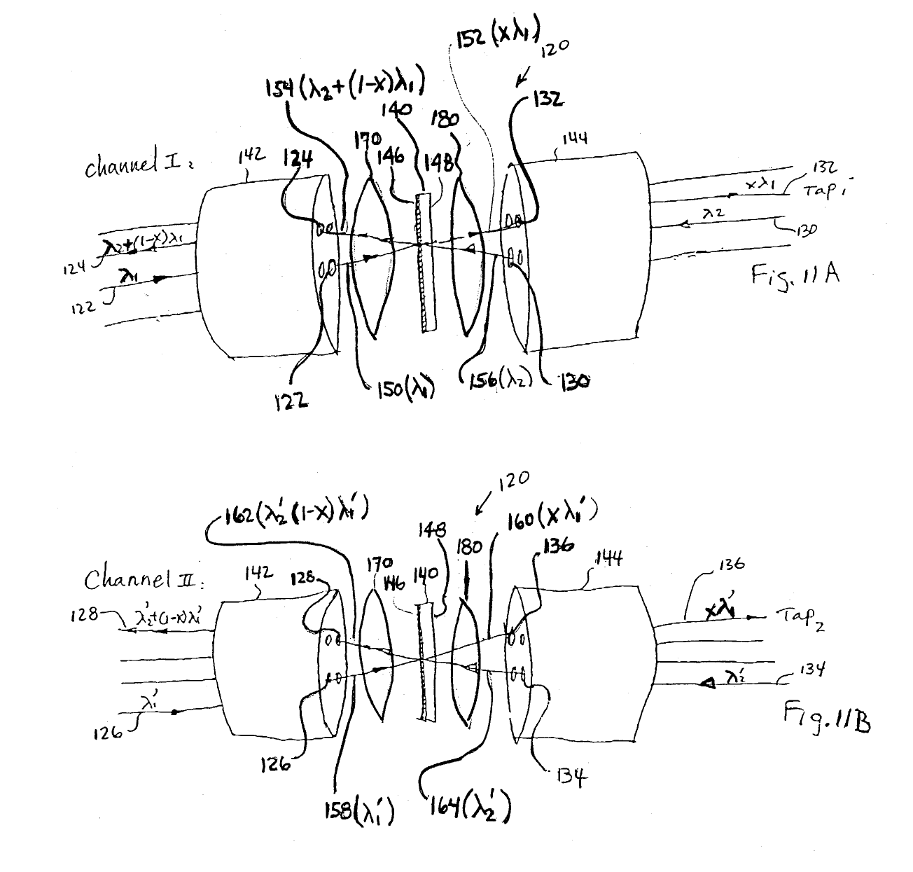

FIG. 10 is an illustrative drawing of a pass characteristic of the partially reflective filter 140 of FIG. 9 used in the coupler 120 configured for a pump combining function. The filter 140 passes a portion (i.e., a percentage) x of light at wavelength λ₁ and passes the remaining portion (i.e., percentage) (1−x) of light at wavelength λ₁. Thus, the filter 140 is partially reflective of light at wavelength λ₁. The filter 140 passes light of wavelength λ₂ .

Referring again to FIG. 8, there is provided a general view of the optical signals emanating to and from the coupler 120. First and second input communications signals, each having a wavelength of λ₁ and each requiring power amplification, are provided to the coupler 120 on the first and third fibers 122, 126. First and second pump light signals, each having a wavelength of λ₂ may be provided to the coupler 120 on the fifth and seventh fibers 130, 134. First and second tap signals, each with wavelength proportions xλ₁, emanate from the coupler 120 on sixth and eighth fibers 132, 136. First and second combined communications/pump signals, each with wavelength proportions λ₂+(1−x)λ₁ emanate from the coupler 120 on second and fourth fibers 124, 128.

FIGS. 11A-11B show additional details of the pump combining coupler 120 of FIG. 8. The drawings of FIGS. 11A-11B are identical except that FIG. 11A shows first internal light paths followed corresponding to a first pump combining function, and FIG. 11B shows second internal light paths corresponding to a second pump combining function. .

The first set of fiber ends 122-128 may be enclosed within a first sleeve segment 142. The first set of fiber ends include a first optical termination. Similarly, the second set of fiber ends 130-136 may be enclosed within a second sleeve segment 144. The second set of fiber ends include a second optical termination. The sleeve segments 142, 144 include respective apertures through which the first set of fiber ends (first to fourth) and the second set of fiber ends (fifth to eighth) extend. The first and second sleeve segments 142, 144 hold the two sets of fiber so that they face each other. In an embodiment, there are the same number of fiber ends in each of the first and second sets of fiber ends. There is a one-to-one correspondence between the fibers in each set. Corresponding fiber ends are aligned with each other. In one embodiment, the fiber ends in the first and second sets may be beveled or angle polished to suppress reflections. A partially reflective filter 140 is disposed between the first set of fibers 122-128 and the second set of fibers 130-136. More specifically, collimating first lens 170 is disposed between a first side 146 of the filter 140 and the first set of fibers 122-128. A second collimating lens 180 is disposed between a second side 148 of the filter 140 and the second set of fibers 130-136.

The first and second sets of fiber ends, 122-128 and 130-136, filter 140 and collimating lenses 170, 180 are arranged to effect the first internal light paths described with reference to FIG. 11A. A first input optical communication signal having wavelength λ₁ is propagated into the coupler 120 on the first fiber 122. The first input optical signal passes from fiber end 122 along a light path indicated by ray 150 through the first collimating lens 170 which collimates the first input light from fiber 122. The collimated first input light is incident upon the first side 146 of the filter 140. A portion xλ₁ of the first signal light passes through the filter 140 and follows the light path indicated by ray 152 through the second collimating lens 180 which collimates the portion xλ₁ of the first input signal light and passes it to the sixth fiber end 132. This passed portion of the first optical signal emanates from the coupler 120 as a first tap signal on the sixth fiber 136. A remaining portion (1−x)λ₁ of the first signal light is reflected by the filter 140 and follows the light path indicated by ray 154 through the first collimating lens 170 which collimates the reflected light and passes it to the second fiber end 124. A first pump signal having a wavelength λ₂ is propagated into the coupler 120 on the fifth fiber 130 and passes from the fifth fiber end 130 and follows a light path indicated by ray 156. The first pump light passes through the second collimating lens 180 which collimates the first pump light and passes it to the second side 148 of filter 140. The first pump light incident on the second side 148 of the filter 140 passes through the filter 140 and follows the light path 154 through the first lens 170 to the second fiber end 124. Thus, the reflected portion of the first optical signal (131 x)λ₁ is combined with a first pump signal λ₂ emanates from the coupler on the second fiber 124.

Similarly, the first and second sets of fiber ends, 122-128 and 130-136, filter 140 and collimating lenses 170, 180 are arranged to effect the second internal light paths described with reference to FIG. 11B. A second input optical communication signal having wavelength λ₁′ is propagated into the coupler 120 on the third fiber 126. (The prime superscripts are used in this paragraph to distinguish the light signals of first internal light paths described in the above paragraph and do not necessarily indicate different wavelengths.) The second input optical signal passes from fiber end 126 along a light path indicated by ray 158 through the first collimating lens 170 which collimates the second input light from fiber 126. The collimated second input light is incident upon the first side 146 of the filter 140. A portion xλ′₁ of the second signal light passes through the filter 140 and follows the light path indicated by ray 160 through the second collimating lens 180 which collimates the portion xλ′₁ of the second input signal light and passes it to the eighth fiber end 136. This passed portion of the second optical signal emanates from the coupler 120 as a second tap signal on the eighth fiber 136. A remaining portion (1−x)λ′₁ of the second signal light is reflected by the filter 140 and follows the light path indicated by ray 162 through the first collimating lens 170 which collimates the reflected light and passes it to the fourth fiber end 128. A second pump signal having a wavelength λ₂′ is propagated into the coupler 120 on the seventh fiber 134 and passes from the seventh fiber end 134 and follows a light path indicated by ray 164. The second pump light passes through the second collimating lens 180 which collimates the second pump light and passes it to the second side 148 of the filter 140. The second pump light incident on the second side 148 of the filter 140 passes through the filter 140 and follows the light path 162 through the first lens 170 to the fourth fiber end 128. Thus, the reflected portion of the second optical signal (1−x)λ₁′ combined with a first pump signal λ₂′ emanates from the coupler 120 on the fourth fiber 128.

Other implementations are within the scope of the above description and the following claims.

What is claimed is:

1. An optical add/drop multiplexer array comprising:
a first optical termination including respective ends of first, second, third and fourth optical fibers;
a second optical termination including respective ends of fifth, sixth, seventh and eighth optical fibers;
a first collimating lens including first and second faces, the first face of the first collimating lens disposed proximate to the ends of the first, second, third and fourth optical fibers;
a second collimating lens including first and second faces, the first face of the second collimating lens disposed proximate the ends of the fifth, sixth, seventh and eighth optical fibers; and
a wavelength dependent filter disposed between the first and second collimating lenses and including a first side disposed proximate the second face of the first collimating lens and including a second side disposed proximate the second face of the second collimating lens;
wherein the respective ends of the first, second, fifth and sixth fibers and the first and second collimating lenses and the wavelength dependent filter are arranged with respect to each other such that, during operation,
light from the first optical fiber that is passed by the wavelength dependent filter passes into the fifth optical fiber and such that,
light from the first optical fiber that is reflected by the wavelength dependent filter passes into the second optical fiber and such that,
light from the sixth optical fiber that is reflected by the wavelength dependent filter passes into the fifth optical fiber; and
wherein the respective ends of the third, fourth, seventh and eighth fibers and the first and second collimating lenses and the wavelength dependent filter are arranged with respect to each other such that, during operation,
light from the third optical fiber that is passed by the wavelength dependent filter passes into the seventh optical fiber and such that,
light from the third optical fiber that is reflected by the wavelength dependent filter passes into the fourth optical fiber and such that,
light from the eighth optical fiber that is reflected by the wavelength dependent filter passes into the seventh optical fiber.

2. The multiplexer array of claim 1 wherein the wavelength dependent filter comprises a thin film filter.

3. The multiplexer array of claim 1 wherein the wavelength dependent filter comprises at least two thin film filters.

4. The multiplexer array of claim 1 wherein the wavelength dependent filter comprises a notch filter.

5. The multiplexer array of claim 1 wherein the first and second collimating lenses are disposed in a confocal relation to each other with the filter disposed near the confocal point.

6. The multiplexer array of claim 1 wherein the respective fiber ends of the optical fibers of the first optical termination are disposed in a mirror image relation with respect to respective corresponding fiber ends of the second optical termination.

7. The multiplexer array of claim 1 wherein,
the wavelength dependent filter comprises a notch filter;
the first and second collimating lenses are disposed in a confocal relation to each other with the filter disposed near the focal point; and
the respective fiber ends of the optical fibers of the first optical termination are disposed in a mirror image relation with respect to respective corresponding fiber ends of the second optical termination.

8. An optical add/drop multiplexer array comprising:
a first optical termination including respective ends of first, second, third and fourth optical fibers;
a second optical termination including respective ends of fifth, sixth, seventh and eighth optical fibers;
a first collimating lens including first and second faces, the first face of the first collimating lens disposed proximate to the ends of the first, second, third and fourth optical fibers;
a second collimating lens including first and second faces, the first face of the second collimating lens disposed proximate the ends of the fifth, sixth, seventh and eighth optical fibers; and
a wavelength dependent filter disposed between the first and second collimating lenses and including a first side disposed proximate the second face of the first collimating lens and including a second side disposed proximate the second face of the second collimating lens;
wherein the respective ends of the first, second, fifth and sixth fibers and the first and second collimating lenses and the wavelength dependent filter are arranged with respect to each other such that, during operation,
light from the first optical fiber that is reflected by the wavelength dependent filter passes into the second optical fiber and such that,
light from the first optical fiber that is passed by the wavelength dependent filter passes into the fifth optical fiber and such that,
light from the sixth optical fiber that is passed by the wavelength dependent filter passes into the second optical fiber; and
wherein the respective ends of the third, fourth, seventh and eighth fibers and the first and second collimating lenses and the wavelength dependent filter are arranged with respect to each other such that, during operation,
light from the third optical fiber that is reflected by the wavelength dependent filter passes into the fourth optical fiber and such that,
light from the third optical fiber that is passed by the wavelength dependent filter passes into the seventh optical fiber and such that,
light from the eighth optical fiber that is passed by the wavelength dependent filter passes into the fourth optical fiber.

9. The multiplexer array of claim 8 wherein the wavelength dependent filter comprises a thin film filter.

10. The multiplexer array of claim 8 wherein the wavelength dependent filter comprises at least two thin film filters.

11. The multiplexer array of claim 8 wherein the wavelength dependent filter comprises a band-pass filter.

12. The multiplexer array of claim 8 wherein the first and second collimating lenses are disposed in a confocal relation to each other with the filter disposed at the confocal point.

13. The multiplexer array of claim 8 wherein the respective fiber ends of the optical fibers of the first optical termination are disposed in a mirror image relation with respect to respective corresponding fiber ends of the second optical termination.

14. The multiplexer array of claim 8 wherein,
the wavelength dependent filter comprises a band-pass filter;
the first and second collimating lenses are disposed in a confocal relation to each other with the filter disposed at the focal point; and
the respective fiber ends of the optical fibers of the first optical termination are disposed in a mirror image relation with respect to respective corresponding fiber ends of the second optical termination.

15. A wavelength division multiplexed coupler comprising:
a first optical termination including respective ends of first, second, third and fourth optical fibers;
a second optical termination including respective ends of fifth, sixth, seventh and eighth optical fibers;
a first collimating lens including first and second end faces, the first end face of the first collimating lens disposed proximate to the ends of the first, second, third and fourth optical fibers;
a second collimating lens including first and second end faces, the first end face of the second collimating lens disposed proximate the ends of the fifth, sixth, seventh and eighth optical fibers; and
a partially reflecting filter disposed between the first and second collimating lenses and including a first side disposed proximate the second end face of the first collimating lens and including a second side disposed proximate the second end face of the second collimating lens;
wherein the respective ends of the first, second, fifth and sixth fibers and the first and second collimating lenses and the partially reflecting filter are arranged with respect to each other such that, during operation,
light from the first optical fiber that is passed by the partially reflecting filter passes into the sixth optical fiber and such that,
light from the first optical fiber that is reflected by the partially reflecting filter passes into the second optical fiber and such that,
light from the fifth optical fiber that is passed by the partially reflecting filter passes into the second optical fiber; and
wherein the respective ends of the third, fourth, seventh and eighth fibers and the first and second collimating lenses and the partially reflecting filter are arranged with respect to each other such that, during operation,
light from the third optical fiber that is passed by the partially reflecting filter passes into the eighth optical fiber and such that,
light from the third optical fiber that is reflected by the partially reflecting filter passes into the fourth optical fiber and such that,
light from the seventh optical fiber that is passed by the partially reflecting filter passes into the fourth optical fiber.

16. The multiplexer array of claim 15 wherein the wavelength dependent filter comprises a thin film filter.

17. The multiplexer array of claim 15 wherein the wavelength dependent filter comprises at least two thin film filters.

18. The multiplexer array of claim 15 wherein the first and second collimating lenses are disposed in a confocal relation to each other with the filter disposed near the confocal point.

19. The multiplexer array of claim 15 wherein the respective fiber ends of the optical fibers of the first optical termination are disposed in a mirror image relation with respect to respective corresponding fiber ends of the second optical termination.

20. The multiplexer array of claim 15 wherein,
the first and second collimating lenses are disposed in a confocal relation to each other with the filter disposed near the focal point; and
the respective fiber ends of the optical fibers of the first optical termination are disposed in a mirror image relation with respect to respective corresponding fiber ends of the second optical termination.
